(19) United States
(12) Patent Application Publication
(10) Pub. No.: US 2020/0336776 A1
(43) Pub. Date: Oct. 22, 2020

(54) METHOD AND SYSTEM FOR PROCESSING VIDEOS FROM MULTIPLE CHANNELS

(71) Applicant: Realtek Semiconductor Corporation, Hsinchu (TW)

(72) Inventors: Jing XIAO, Changsha City (CN); Chun-Yi CHEN, Hsinchu (TW); Feng-Juan WANG, Changsha City (CN)

(21) Appl. No.: 16/774,326

(22) Filed: Jan. 28, 2020

(30) Foreign Application Priority Data
Apr. 16, 2019 (CN) 201910304130.7

(51) Int. Cl. H04N 21/2665; H04N 21/44; H04N 21/81

(52) U.S. Cl. CPC H04N 21/2665; H04N 21/8193; H04N 21/44004

(57) ABSTRACT

A processing method for processing videos from multiple channels includes: assigning first multimedia data to a hardware decoder circuit to generate first decoded data; assigning second multimedia data to a software decoder circuit to generate second decoded data; and duplicating the first decoded data and the second decode data to a video buffer according to a predetermined arrangement and an encoding format to generate output data, for being displayed by a screen. The predetermined arrangement indicates an arrangement of display regions corresponding to the first multimedia data and the second multimedia data on the screen.

### RELATED APPLICATIONS

This application claims priority to Chinese Application Serial Number 201910304130.7, filed Apr. 16, 2019, which is herein incorporated by reference.

### BACKGROUND

### Technical Field

The present disclosure relates to a processing method and a processing system for processing videos from multiple channels. More particularly, the present disclosure relates to a processing method and a processing system for processing videos from multiple channels based on hardware and software decoding.

### Description of Related Art

In some practical applications (such as monitoring), users need to watch multiple videos from multiple sources simultaneously. However, when the number of videos is too many, the prior art requires more processing time and can not play multiple videos in real time.

### SUMMARY

One embodiment of the present disclosure is related to a processing method for processing videos from multiple channels that includes: assigning first multimedia data to a hardware decoder circuit to generate first decoded data; assigning second multimedia data to a software decoder circuit to generate second decoded data; and duplicating the first decoded data and the second decoded data to a video buffer according to a predetermined arrangement and an encoding format to generate output data, for being displayed by a screen, in which predetermined arrangement indicates an arrangement of display regions corresponding to the first multimedia data and the second multimedia data on the screen.

One embodiment of the present disclosure is related to a processing system for processing videos from multiple channels that includes a hardware decoder circuit, a software decoder circuit, at least one memory, and a data combination circuit. The hardware decoder circuit is configured to decode first multimedia data to generate first decoded data. The software decoder circuit is configured to decode second multimedia data to generate second decoded data. The at least one memory is configured to provide a plurality of frame buffers to store the first decoded data and the second decoded data, and provide a video buffer. The data combination circuit is configured to duplicate the first decoded data and the second decoded data to the video buffer according to a predetermined arrangement and an encoding format to generate output data, for being displayed by a screen. The predetermined arrangement indicates an arrangement of display regions corresponding to the first multimedia data and the second multimedia data on the screen.

As the above embodiments, the processing system and processing method for processing the videos from multiple channels of the present embodiment can utilize the hardware/software decoder circuit(s) to process the multimedia data of multiple channels and improve the compatibility of video formats. In addition, the real-time play of the video is improved.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a processing system for processing videos from multiple channels according to some embodiments of the present disclosure.

FIG. 2A to FIG. 2C are a plurality of schematic diagrams of presenting videos on a screen in FIG. 1 respectively according to some embodiments of the present disclosure.

FIG. 3A is a flowchart of a hardware decoding method according to some embodiments of the present disclosure.

FIG. 3B is a schematic diagram of a ring buffer in FIG. 1 according to some embodiments of the present disclosure.

FIG. 4 a flowchart of a processing method for processing videos from multiple channels according to some embodiments of the present disclosure.

FIG. 5 is a schematic diagram of duplicating decoded data according to some embodiments of the present disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. The embodiments below are described in detail with the accompanying drawings, but the examples provided are not intended to limit the scope of the disclosure covered by the description. The structure and operation are not intended to limit the execution order. Any structure regrouped by elements, which has an equal effect, is covered by the scope of the present disclosure.

As used herein, “the first”, “the second”, . . . etc. do not refer to the order or priority, nor are they intended to limit the present disclosure. They are merely used to distinguish the elements or operations described with the same technical terms. It will be understood that, as used herein, the phrase “and/or” includes any and all combinations of one or more of the associated listed items.

In this document, the term “coupled” may also be referred to “electrically coupled,” and the term “connected” may be referred to “electrically connected.” “Coupled” and “connected” may be referred to “directly coupled” and “directly connected” respectively, or “indirectly coupled” and “indirectly connected” respectively. “Coupled” and “connected” may also be used to indicate that two or more elements cooperate or interact with each other.

In this document, the term “circuitry” may indicate a system formed with one or more circuits. The term “circuit” may indicate an object, which is formed with one or more transistors and/or one or more active/passive elements based on a specific arrangement, for processing signals.

For ease of understanding, like elements in the shown figures are designated with the same reference numbers.

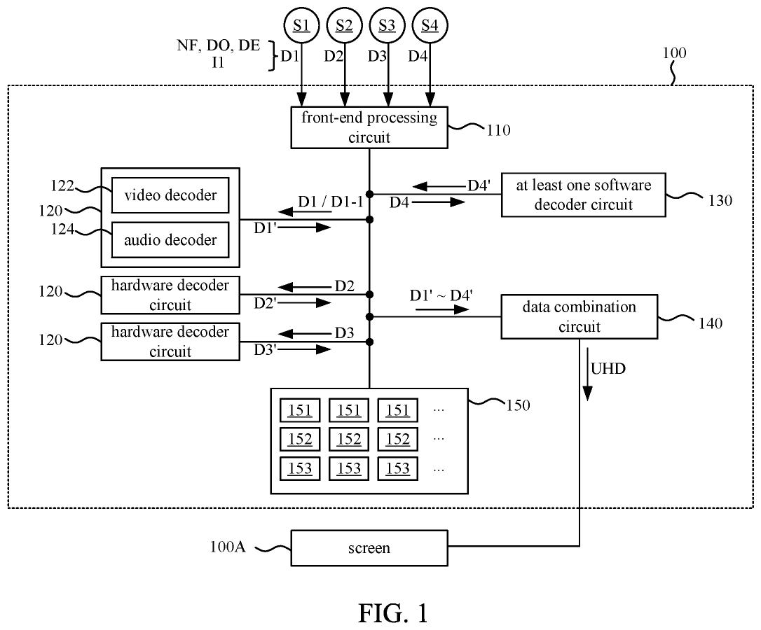

FIG. 1 is a schematic diagram of a processing system for processing videos from multiple channels 100 according to some embodiments of the present disclosure. In some embodiments, the processing system for processing the videos from multiple channels 100 can receive video data from different sources (for example, different cameras or different signal sources on the network) from multiple channels, and play multiple different videos in real time.

The processing system for processing the videos from multiple channels 100 includes a front-end processing circuit 110, at least one hardware decoder circuit 120, at least one software decoder circuit 130, a data combination circuit 140, and at least one memory 150.

In some embodiments, the front-end processing circuit 110, the at least one software decoder circuit 130, the data combination circuit 140 may be implemented by one or more processing circuits or application specific integrated circuits.

The front-end processing circuit 110 may be coupled to multiple video sources S1-S4 via a wired or wireless network to respectively receive multimedia data D1-D4. The front-end processing circuit 110 can parse at least one of the multimedia data D1-D4 based on one or more libraries to obtain multimedia information I1 including link URLs, stream types, video data and/or audio data, etc. corresponding to the multimedia data D1-D4. In some embodiments, the above libraries are configured to process video and/or audio, and may be stored in the at least one memory 150. In some embodiments, the above libraries may be provided by a third party or a client, but the preset disclosure is not limited thereto.

The multiple video sources S1-S4 may be different file sources in a same device or multiple independent electronic devices. In some embodiments, the multimedia data D1-D4 may be local videos. In some embodiments, the multimedia data D1-D4 may be streaming data transmitted according to a protocol including the User Datagram Protocol (UDP), the Transmission Control Protocol (TCP), or the Real Time Streaming Protocol (RTSP), etc., but the preset disclosure is not limited thereto.

The at least one hardware decoder circuit 120 performs a video decoding operation based on hardware. In some embodiments, the hardware decoder circuit 120 may be implemented by at least one image/audio processing engine circuit, at least one display chip, at least one audio processing chip, and/or at least one application specific integrated circuit, but the preset disclosure is not limited thereto.

In some embodiments, the at least one hardware decoder circuit 120 is disposed to process at least one of the multimedia data D1-D4. For example, as shown in FIG. 1, the processing system for processing the videos from multiple channels 100 includes three hardware decoder circuits 120, which perform decoding operations respectively based on the multimedia data D1-D3 so as to generate decoded data D1′-D3′.

In some embodiments, the hardware decoder circuit 120 includes a video decoder 122 and an audio decoder 124. Take the multimedia data D1 as an example, the multimedia data D1 is transmitted to the video decoder 122 for decoding when the front-end processing circuit 110 determines that the multimedia data D1 is video data according to the stream type. Alternatively, the multimedia data D1 is transmitted to the audio decoder 124 for decoding when the front-end processing circuit 110 determines that the multimedia data D1 is audio data according to the stream type.

In some embodiments, each of the hardware decoder circuits 120 is configured to perform a decoding operation on one frame of video data to generate an image. In some embodiments, the front-end processing circuit 110 is configured to determine scan methods of the multimedia data D1-D4. Take the multimedia data D1 as an example, after parsing the multimedia data D1, the front-end processing circuit 110 can directly transmit the multimedia data D1 to the corresponding hardware decoder circuit 120 for a decoding process when the front-end processing circuit 110 can confirm that a display format of the multimedia data D1 is progressive scanning according to the multimedia information I1. Alternatively, when the display format of the multimedia data D1 is interlace scanning, the front-end processing circuit 110 further parses a number of frames NF, odd field data DO, and even field data DE of the multimedia data D1 to combine them into one frame of video data D1-1, and transmits the one frame of video data D1-1 to the corresponding hardware decoder circuit 120 for the decoding process.

The at least one software decoder circuit 130 performs a video decoding operation based on software. In some embodiments, the at least one software decoder circuit 130 processes at least one of the multimedia data D1-D4. For example, as shown in FIG. 1, the processing system for processing the videos from multiple channels 100 includes one software decoder circuit 130, which performs a decoding operation based on the multimedia data D4. The software decoder circuit 130 can read and execute an application (not shown) or a third-party library from the at least one memory 150 to generate decoded data D4′ based on the video data D4. In some embodiments, the at least one software decoder circuit 130 may be implemented by at least one processing circuit cooperating with one or more video/audio decoding programs stored in the memory 150.

The data combination circuit 140 is coupled to at least one of the hardware decoder circuits 120 and at least one of the software decoder circuits 130 to receive the decoded data D1′-D4′. The data combination circuit 140 is configured to duplicate the decoded data D1′-D4′ to a video buffer 151 in the at least one memory 150, to combine them into output data UHD. The data combination circuit 140 can provide the output data UHD to a screen 100A to simultaneously display video contents of the multimedia data D1-D4.

The at least one memory 150 is configured to provide a temporary storage space required by the decoding operations of at least one of the hardware decoder circuits 120 and at least one of the software decoder circuits 130 and a storage space for storing the output data UHD. In some embodiments, the at least one memory 150 may be any and all combinations of a non-transitory computer readable medium, a hard disk, a dynamic random access memory, and a static random access memory, but the present disclosure is not limited thereto.

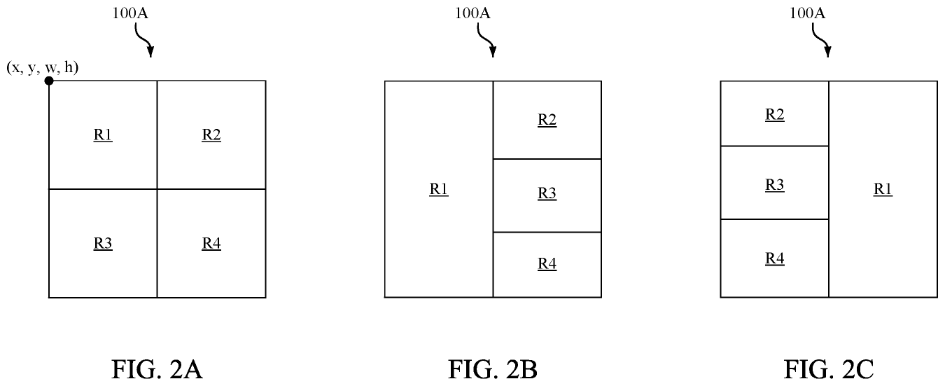

FIG. 2A to FIG. 2C are a plurality of schematic diagrams of presenting videos on the screen 100A in FIG. 1 respectively according to some embodiments of the present disclosure. As shown in FIG. 2A to FIG. 2C, the screen 100A has four regions R1-R4, which are respectively configured to display contents of the decoded data D1′-D4′. In the example of FIG. 2A, areas of the four regions R1-R4 are the same. Alternatively, in the example of FIG. 2B, the region R1 is located on a left side of the screen 100A and has a largest area to display main content. The other regions R2 to R4 have a same area and are located on a right side of the screen 100A. Compared to FIG. 2B, the region R1 is located on the right side of the screen 100A and has the largest area to display main content in the example of FIG. 2C. The other regions R2 to R4 have the same area and are located on the left side of the screen 100A.

The above various types of presentation can be used to simultaneously display multiple videos from multiple channels, so that a user can conveniently view multiple multimedia contents or perform monitoring. The above various types of presentation are given for illustrative purposes, and the present disclosure is not limited thereto.

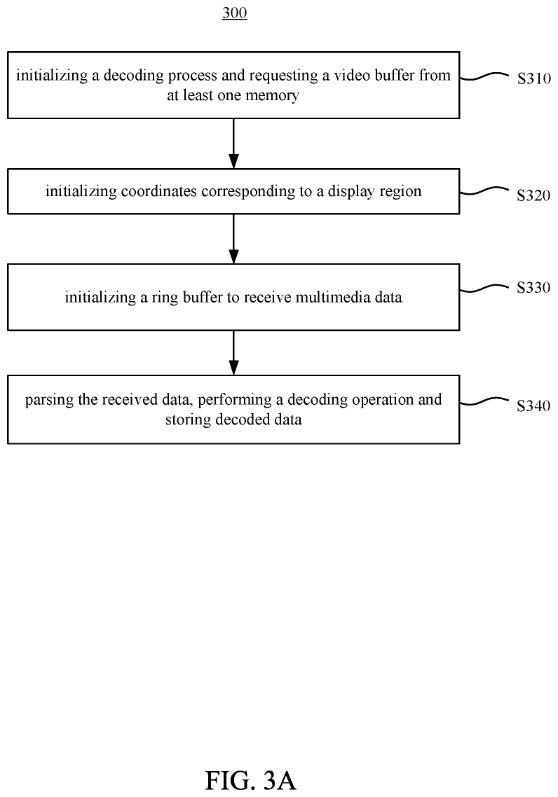

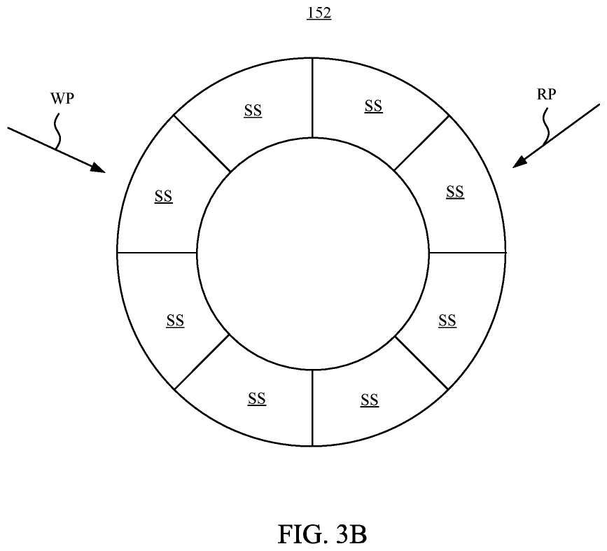

FIG. 3A is a flowchart of a hardware decoding method 300 according to some embodiments of the present disclosure. In some embodiments, the hardware decoding method 300 can be executed by one of the hardware decoder circuits 120 in FIG. 1. For ease of illustration, the hardware decoder circuit 120 for processing the multimedia data D1 in FIG. 1 is taken as an example, and the operations of the other hardware decoder circuits 120 can be deduced by analogy.

In operation S310, a decoding process is initialized, and a video buffer from at least one memory is requested.

For example, the hardware decoder circuit 120 can ask the at least one memory 150 to provide a plurality of video buffers 151 before decoding is started. Accordingly, the video buffers 151 can be assigned to the hardware decoder circuit 120 for a decoding operation. In some embodiments, the plurality of video buffers 151 in FIG. 1 may be shared by all of the hardware decoder circuits 120.

In step S320, coordinates corresponding to a display region are initialized.

FIG. 2A is taken as an example. If a display region corresponding to the hardware decoder circuit 120 is the region R1, coordinates (x, y, w, h) of one corner (for example, an upper left corner) of the region R1 are initialized and recorded in the memory 150. Here, x and y represent the coordinates of this corner of the region R1, w is a width of the region R1, and h is a height of the region R1.

In operation S330, a ring buffer is initialized to receive multimedia data.

In some embodiments, the hardware decoder circuit 120 can send a request to the at least one memory 150, to establish a ring buffer 152. The ring buffer 152 is configured to receive the multimedia data D1 or the video data D1-1 directly transmitted from the front-end processing circuit 110.

FIG. 3B is a schematic diagram of the ring buffer 152 in FIG. 1 according to some embodiments of the present disclosure. As shown in FIG. 3B, the ring buffer 152 includes a plurality of storage spaces SS. The hardware decoder circuit 120 for processing the multimedia data D1 is taken as an example. The hardware decoder circuit 120 can control the plurality of storage spaces SS by using a write indicator WP and a read indicator RP. When receiving the multimedia data D1 or the video data D1-1, the hardware decoder circuit 120 can utilize a difference between the write indicator WP and the read indicator RP to determine an available storage space of the ring buffer 152, to write received data and update the write indicator WP. The hardware decoder circuit 120 can use the read indicator RP to read the received data and update the read indicator RP. In some embodiments, a capacity of the ring buffer 152 is approximately 8 million bytes (Megabyte, MB), but the present disclosure is not limited in this regard.

Reference is made to FIG. 3A again. In operation S340, the received data is parsed, a decoding operation is performed, and decoded data is stored.

When receiving the multimedia data D1 or the video data D1-1 for the first time, the hardware decoder circuit 120 can parse the data to obtain the related multimedia information I1 (for example, encoding format, image length and width, etc.). Then, the hardware decoder circuit 120 can send a request to the at least one memory 150, to apply for a plurality of (for example, may be but not limited to 6) frame buffers 153. The frame buffers 153 can store the decoded data D1′. In some embodiments, a capacity of each of the frame buffers 153 may be determined based on the above related image information. For example, the encoding format is YUV, the length is 1920, and the width is 1080. Under this condition, since each pixel includes 1-bit Y component data and 0.5-bit UV component data, the capacity of the frame buffer 153 can be determined to be 1920×1080×3/2=3110400 bits. In some embodiments, the frame buffer 153 may be so disposed to be allocated according to the management mechanism of ION to improve the data duplicating speed.

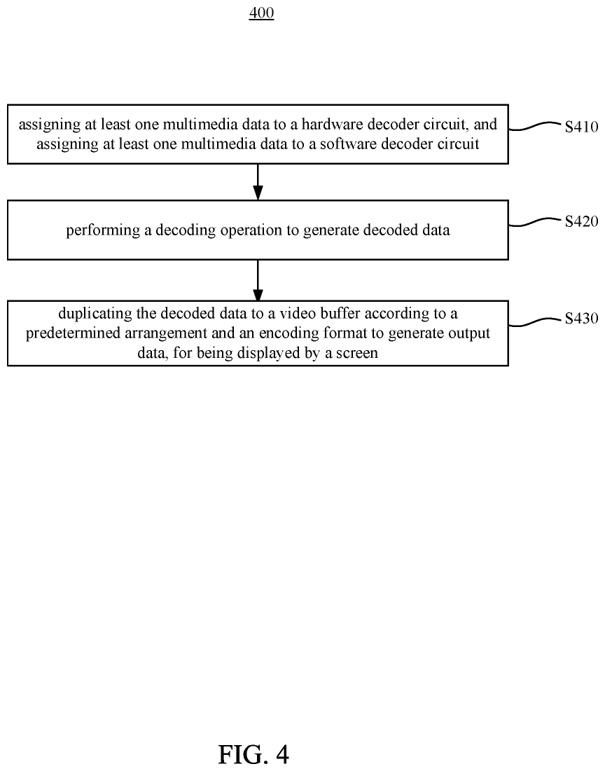

FIG. 4 a flowchart of a processing method for processing videos from multiple channels 400 according to some embodiments of the present disclosure. For ease of understanding, the method for processing the videos from multiple channels 400 is described with reference to the processing system for processing the videos from multiple channels 100 of FIG. 1.

In operation S410, at least one multimedia data is assigned to a hardware decoder circuit, and at least one multimedia data is assigned to a software decoder circuit.

For example, as shown in FIG. 1, the front-end processing circuit 110 assigns three multimedia data D1-D3 to the plurality of hardware decoder circuits 120, and assigns one multimedia data D4 to the software decoder circuit 130. However, the present disclosure is not limited thereto. In other examples, the multimedia data D1-D2 may be assigned to the plurality of hardware decoder circuits 120, and the multimedia data D3-D4 may be assigned to the software decoder circuit 130. The present disclosure is also not limited to the number of multimedia data and/or the number of circuits of FIG. 1.

In operation S420, a decoding operation is performed to generate decoded data. Since the operations here may refer to the above description of FIG. 3A to FIG. 3B, a description in this regard is not repeated.

In operation S430, the decoded data is duplicated to a video buffer according to a predetermined arrangement and an encoding format to generate output data for being displayed by a screen.

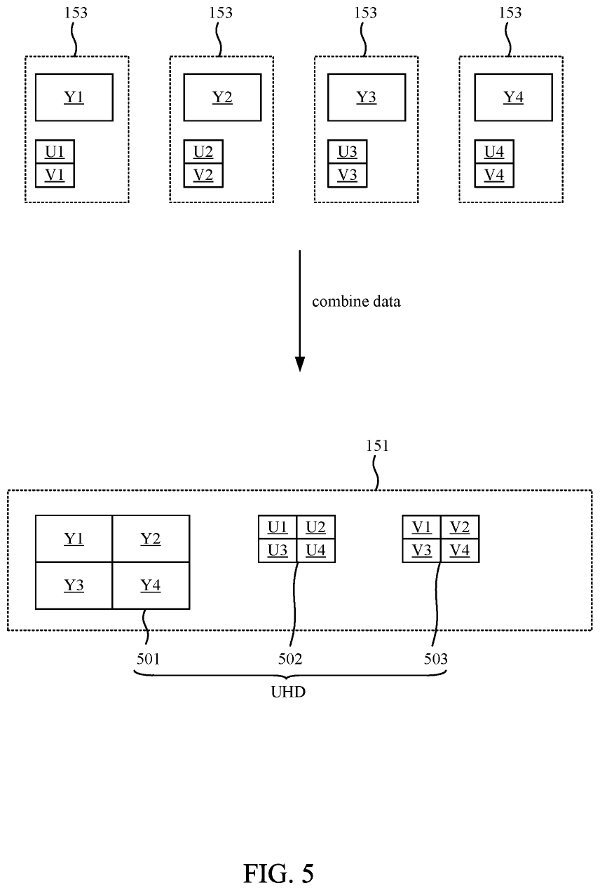

FIG. 5 is a schematic diagram of duplicating decoded data according to some embodiments of the present disclosure. As shown in FIG. 5, if the multimedia data D1-D4 is in a YUV format, the decoded data D1′ includes component data Y1, U1, and V1. By analogy, the decoded data D2′ includes component data Y2, U2 and V2, the decoded data D3′ includes component data Y3, U3 and V3, and the decoded data D4′ includes component data Y4, U4 and V4. The component data Y1-Y4 corresponds to a Y component in YUV, the component data U1-U4 corresponds to a U component, and the component data V1-V4 corresponds to a V component. As mentioned previously, the decoded data D1′-D4′ is stored in the plurality of frame buffers 153.

When data stored in the frame buffers 153 corresponds to one frame of image data, the data combination circuit 140 can duplicate the data stored in the frame buffers 153 to the video buffer 151 according to a predetermined arrangement and an encoding format (that is, YUV). The predetermined arrangement indicates an arrangement of display regions corresponding to the multimedia data D1-D4 on the screen 100A (that is, an arrangement of the regions R1-R4).

FIG. 2A is taken as an example. The data combination circuit 140 can combine the component data Y1-Y4 to be a portion 501 of the output data UHD according to the arrangement of the regions R1-R4 and store it in the video buffer 151. By analogy, the data combination circuit 140 combines the component data U1-U4 to be a portion 502 of the output data UHD and combines the component data V1-V4 to be a portion 503 of the output data UHD, and store them in the video buffer 151. After the video buffer 151 receives the complete output data UHD, the data combination circuit 140 provides the output data UHD to the screen 100A so as to display the video contents of the multimedia data D1-D4.

The above description of the method 300 or 400 includes exemplary operations, but the operations of the method 300 or 400 are not necessarily performed in the order described above. The order of the operations of the method 300 or 400 can be changed, or the operations can be executed simultaneously or partially simultaneously as appropriate, in accordance with the spirit and scope of various embodiments of the present disclosure.

In some related technologies, multiple multimedia data from multiple channels still need to be encoded as a single video stream after being decoded and is then played. In the above technologies, owing to the additional encoding operation, more operation time needs to be consumed so that a real-time play can not be achieved. Or, in some related technologies, only hardware decoding is used to process multimedia data of up to two channels. In the above technologies, the multimedia data of the two channels must be in a same video format.

As compared with the above technologies, the embodiments of the present disclosure deploy the plurality of hardware decoder circuit(s) and software decoder circuit(s), which can improve the compatibility of video formats and make full use of the assignment of the hardware/software decoder circuit(s) to eliminate the additional encoding operation. As a result, the real-time play of the video can be improved.

As the above embodiments, the processing system and processing method for processing the videos from multiple channels of the present embodiment can utilize the hardware/software decoder circuit(s) to process the multimedia data of multiple channels and improve the compatibility of video formats. In addition, the real-time play of the video is improved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A processing method for processing videos from multiple channels comprising:
assigning first multimedia data to a hardware decoder circuit to generate first decoded data;
assigning second multimedia data to a software decoder circuit to generate second decoded data; and
duplicating the first decoded data and the second decoded data to a video buffer according to a predetermined arrangement and an encoding format to generate output data, for being displayed by a screen,
wherein the predetermined arrangement indicates an arrangement of display regions corresponding to the first multimedia data and the second multimedia data on the screen.

2. The processing method for processing videos from multiple channels of claim 1, wherein assigning the first multimedia data to the hardware decoder circuit to generate the first decoded data comprises:
requesting the video buffer from at least one memory;
initializing a ring buffer to receive the first multimedia data; and
parsing the first multimedia data to generate the first decoded data, and storing the first decoded data in a plurality of frame buffers in the at least one memory.

3. The processing method for processing videos from multiple channels of claim 2, wherein initializing the ring buffer to receive the first multimedia data comprises:
requesting the ring buffer from the at least one memory;
controlling a write indicator to write the first multimedia data into the ring buffer; and
controlling a read indicator to read the first multimedia data from the ring buffer, to decode the first multimedia data.

4. The processing method for processing videos from multiple channels of claim 2, wherein a capacity of each of the frame buffers is determined based on image information of the first multimedia data.

5. The processing method for processing videos from multiple channels of claim 1, further comprising:
if a display format of the first multimedia data is progressive scanning, transmitting the first multimedia data to the hardware decoder circuit directly, to generate the first decoded data.

6. The processing method for processing videos from multiple channels of claim 1, further comprising:
if a display format of the first multimedia data is interlace scanning, generating one frame of video data based on a number of frames, odd field data, and even field data related to the first multimedia data, and transmitting the one frame of video data to the hardware decoder circuit, to generate the first decoded data.

7. The processing method for processing videos from multiple channels of claim 1, wherein the first decoded data comprises first component data and second component data, and the second decoded data comprises third component data and fourth component data according to the encoding format, wherein duplicating the first decoded data and the second decoded data to the video buffer according to the predetermined arrangement and the encoding format to generate the output data for being displayed by the screen comprises:
according to the predetermined arrangement, combining the first component data and the third component data to be a first portion of the output data; and
according to the predetermined arrangement, combining the second component data and the fourth component data to be a second portion of the output data, to generate the output data.

8. The processing method for processing videos from multiple channels of claim 7, wherein the encoding format is at least defined by a first component and a second component, the first component data and the third component data correspond to the first component, and the second component data and the fourth component data correspond to the second component.

9. A processing system for processing videos from multiple channels comprising:
a hardware decoder circuit configured to decode first multimedia data to generate first decoded data;
a software decoder circuit configured to decode second multimedia data to generate second decoded data;
at least one memory configured to provide a plurality of frame buffers to store the first decoded data and the second decoded data, and provide a video buffer; and
a data combination circuit configured to duplicate the first decoded data and the second decoded data to the video buffer according to a predetermined arrangement and an encoding format to generate output data, for being displayed by a screen,
wherein the predetermined arrangement indicates an arrangement of display regions corresponding to the first multimedia data and the second multimedia data on the screen.

10. The processing system for processing videos from multiple channels of claim 9, further comprising:
a front-end processing circuit configured to assign the first multimedia data to at least one hardware decoder circuit, and assign the second multimedia data to at least one software decoder circuit.

11. The processing system for processing videos from multiple channels of claim 10, wherein if a display format of the first multimedia data is progressive scanning, the front-end processing circuit is further configured to transmit the first multimedia data to the hardware decoder circuit directly, to generate the first decoded data.

12. The processing system for processing videos from multiple channels of claim 10, wherein if a display format of the first multimedia data is interlace scanning, the front-end processing circuit is further configured to generate one frame of video data based on a number of frames, odd field data, and even field data related to the first multimedia data, and transmit the one frame of video data to the hardware decoder circuit, to generate the first decoded data.

13. The processing system for processing videos from multiple channels of claim 9, wherein the first decoded data comprises first component data and second component data, and the second decoded data comprises third component data and fourth component data according to the encoding format, wherein the data combination circuit is configured to combine the first component data and the third component data to be a first portion of the output data, and combine the second component data and the fourth component data to be a second portion of the output data according to the predetermined arrangement to generate the output data.

14. The processing system for processing videos from multiple channels of claim 13, wherein the encoding format is at least defined by a first component and a second component, the first component data and the third component data correspond to the first component, and the second component data and the fourth component data correspond to the second component.

15. The processing system for processing videos from multiple channels of claim 9, wherein the hardware decoder circuit is configured to request the video buffer from the at least one memory, initialize a ring buffer to receive the first multimedia data, parse the first multimedia data to generate the first decoded data, and store the first decoded data in the frame buffers.

16. The processing system for processing videos from multiple channels of claim 15, wherein the hardware decoder circuit is configured to request the ring buffer from the at least one memory, control a write indicator to write the first multimedia data into the ring buffer, and control a read indicator to read the first multimedia data from the ring buffer, to decode the first multimedia data.

17. The processing system for processing videos from multiple channels of claim 9, wherein a capacity of each of the frame buffers is determined based on image information of the first multimedia data.
